(19) United States
(12) Patent Application Publication
(10) Pub. No.: US 2006/0013311 A1
(43) Pub. Date: Jan. 19, 2006

(54) Video decoding method using smoothing filter and video decoder therefor

(75) Inventor: Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/153,410

(22) Filed: Jun. 16, 2005

(30) Foreign Application Priority Data
Jul. 15, 2004 (KR) 10-2004-0055284

(51) Int. Cl. H04N 11/04

(52) U.S. Cl. 375/240.19

(57) ABSTRACT

A method and apparatus for increasing output picture quality at a decoding terminal by using a smoothing filter are provided. The video decoding method includes generating a residual frame from an input bitstream, performing wavelet-based upsampling on the residual frame, performing non-wavelet-based downsampling on the upsampled frame, and performing inverse temporal filtering on the downsampled frame.

### CROSS-REFERENCE TO RELATED APPLICATION

This application claims priority from Korean Patent Application No. 10-2004-0055284 filed on Jul. 15, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to video compression, and more particularly, to increasing output picture quality at a decoding terminal by using a smoothing filter.

2. Description of the Related Art

With the development of information communication technology including the Internet, video communication as well as text and voice communication has increased. Conventional text communication cannot satisfy the various demands of users, and thus multimedia services that can provide various types of information such as text, pictures, and music have increased. Multimedia data requires a large capacity storage medium and a wide bandwidth for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency. Data compression can be classified as lossy/lossless compression according to whether source data is lost, intraframe/interframe compression according to whether individual frames are compressed independently, and symmetric/asymmetric compression according to whether time required for compression is the same as time required for recovery. Data compression is defined as real-time compression when a compression/recovery time delay does not exceed 50 ms and as scalable compression when frames have different resolutions. For text or medical data, lossless compression is usually used. For multimedia data, lossy compression is usually used. Meanwhile, intraframe compression is usually used to remove spatial redundancy, and interframe compression is usually used to remove temporal redundancy.

Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. In conventional video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream since they use a reflexive approach in a main algorithm.

Accordingly, many studies on wavelet-based scalable video coding have recently been performed. Scalable video coding has scalability in a spatial domain, i.e., in terms of resolution. Scalability indicates possibility of partially decoding a single compressed bitstream, i.e., possibility of reproducing video at diverse resolutions from the bitstream.

Scalability includes spatial scalability indicating a video resolution, signal-to-noise ratio (SNR) scalability indicating a video quality level, temporal scalability indicating a frame rate, and combinations thereof.

Spatial scalability can be implemented by wavelet transform. SNR scalability can be implemented by quantization. Meanwhile, examples of recently proposed methods for implementing temporal scalability include Motion Compensated Temporal Filtering (MCTF), Unconstrained MCTF (UMCTF), and so on.

FIG. 1 illustrates the structure of a video coding system supporting scalability. An encoder 40 encodes an input video 10 by performing temporal filtering, spatial transform, and quantization, thereby generating a bitstream 20. A pre-decoder 50 clips or extracts a part from the bitstream 20 received from the encoder according to a condition, for example, picture quality, resolution, or a frame rate, defined taking account of an environment for communication with a decoder 60 or mechanical performance of the decoder 60, thereby simply accomplishing scalability with respect to texture data.

The decoder 60 performs the operations performed by the encoder 40 on an extracted bitstream 25 in reverse way, thereby generating an output video 30. Extracting the part of the bitstream 20 is not necessarily performed by the pre-decoder 50 but may be performed by the decoder 60 when the decoder 60 does not have sufficient processing power to process the whole video of the bitstream 20 received from the encoder 40 in real time. It is apparent that the extracting the part of the bitstream 20 can be performed by both of the pre-decoder 50 and the decoder 60.

To support spatial scalability, wavelet transform may be used. The wavelet transform makes most of energy converge into a low band, and therefore, the low band has a too high detail level in a particular resolution. For example, a quarter common intermediate format (QCIF) sequence resulting from downsampling in the wavelet transform has a much higher detail level than a sequence obtained using an MPEG downsampling filter. As a result, good picture quality cannot be provided temporally.

As compared to downsampling in the wavelet transform, discrete cosine transform (DCT)-based downsamplers such as MPEG coding and H.264, i.e., advanced video coding (AVC), provide visually softer images especially for low bit rate images. However, these DCT-based coding methods do not properly support spatial scalability.

Therefore, a coding method that supports spatial scalability and simultaneously provides a smoothing characteristic accomplished by downsampling performed according to DCT-based coding methods is desired.

### SUMMARY OF THE INVENTION

The present invention provides a decoding method and a decoder, which provide softer picture quality in wavelet-based scalable decoding.

According to an aspect of the present invention, there is provided a video decoding method including generating a residual frame from an input bitstream, performing wavelet-based upsampling on the residual frame, performing non-wavelet-based downsampling on the upsampled frame, and performing inverse temporal filtering on the downsampled frame.

According to another aspect of the present invention, there is provided a video decoding method including generating a residual frame from an input bitstream, performing inverse temporal filtering on the residual frame to restore a video sequence, performing wavelet-based upsampling on the video sequence, and performing non-wavelet-based downsampling on the upsampled video sequence.

According to still another aspect of the present invention, there is provided a video decoder including an inverse spatial transformation module generating a residual frame from an input bitstream, a smoothing filter module performing wavelet-based upsampling and non-wavelet-based downsampling on the residual frame, and an inverse temporal filtering module performing inverse temporal filtering on the downsampled frame.

According to yet another aspect of the present invention, there is provided a video decoder including an inverse spatial transformation module generating a residual frame from an input bitstream, an inverse temporal filtering module performing inverse temporal filtering on the residual frame to restore a video sequence, and a smoothing filter module performing wavelet-based upsampling and non-wavelet-based downsampling on the video sequence.

### BRIEF DESCRIPTION OF THE DRAWINGS

The above and other aspects of the present invention will become more apparent by describing in detail exemplary embodiments thereof with reference to the attached drawings in which:

FIG. 1 illustrates the entire structure of a conventional scalable video coding system;

FIG. 2 is a schematic diagram of a scalable video coder according to an exemplary embodiment of the present invention;

FIGS. 3A and 3B illustrate examples of applying a smoothing filter to an encoder shown in FIG. 2;

FIG. 4 illustrates downsampling through wavelet transform and upsampling through inverse wavelet transform;

FIG. 5 illustrates DCT-based down/upsampling;

FIG. 6 is a diagram of a scalable video encoder according to an exemplary embodiment of the present invention;

FIG. 7 illustrates an example of a procedure for decomposing an input image or frame into sub-bands using wavelet transform;

FIG. 8 illustrates the structure of a bitstream transmitted from an encoder;

FIG. 9 illustrates the structure of a scalable bitstream;

FIG. 10 illustrates the detailed structure of a group of picture (GOP) field;

FIG. 11 illustrates a scalable video decoder according to an exemplary embodiment of the present invention;

FIG. 12 illustrates a scalable video decoder according to another exemplary embodiment of the present invention; and

FIG. 13 is a graph of a bit rate versus a peak signal-to-noise ratio (PSNR) in a mobile sequence.

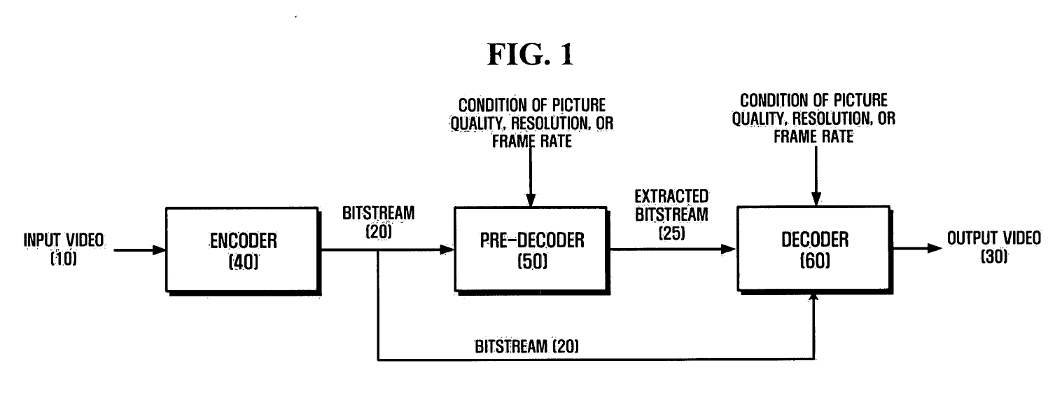

### DETAILED DESCRIPTION OF EXEMPLARY EMBODIMENTS OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Scalable video coding is advantageous in that all of a bit rate, a resolution, and a frame rate can be transformed by the pre-decoder 50 and a very high compression rate at a high bit rate is provided. However, when a bit rate is not high, the performance of scalable video coding rapidly decreases as compared to coding methods such as Motion Picture Experts Group (MPEG)-4 and H.264.

This is because wavelet transform performance is lower than DCT performance at a low resolution. In addition, since scalable video coding must support diverse bit rates, but encoding is performed at an optimized bit rate among the diverse bit rates, the performance of the scalable video coding decreases at other bit rates.

To overcome these problems, downsampled reference, i.e., a temporal base layer is used in wavelet-based spatial-scalable video coders. The present invention can be effectively used in scalable video coders using a base layer and also can be used in usual scalable video coders that do not use the base layer.

The present invention is provided to restore frames having softer picture quality when a decoder decodes a bitstream that has been subjected to spatial scale transformation in a pre-decoder. Accordingly, when a spatial scale is not transformed, for example, when only a picture quality scale and a temporal scale are transformed in the pre-decoder, a procedure using a smoothing filter provided by the present invention is not necessary because a frame having an original resolution is optimal in light of visual picture quality.

Accordingly, it is assumed that a certain level of spatial scalability has been given and resolution has been decreased by one level in the pre-decoder.

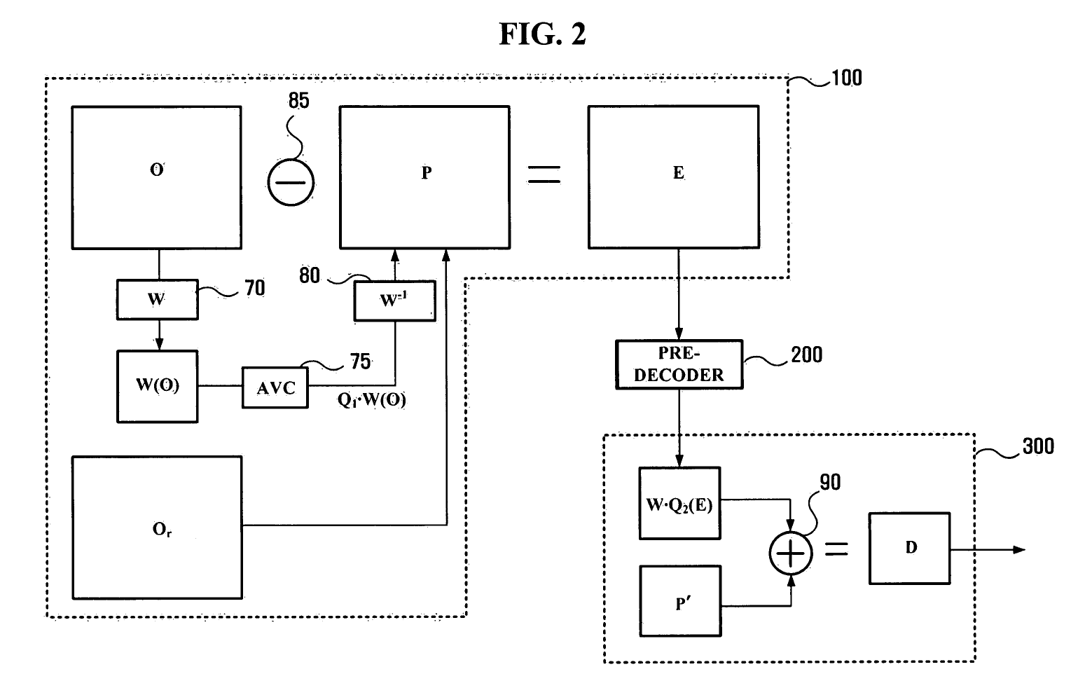

FIG. 2 is a schematic diagram of a scalable video coder according to an exemplary embodiment of the present invention.

In the operation of an encoder 100, an original frame O is downsampled by a wavelet transform module (W) 70. The downsampled frame, i.e., a base layer is represented with W(O). The base layer W(O) is upsampled by an inverse wavelet transform module (W⁻¹) 80. The upsampled base layer is provided to a temporal filtering module 85 as a prediction frame P.

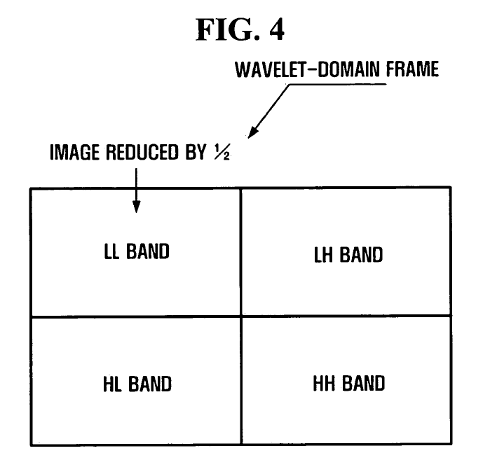

For balance between the encoder 100 and a decoder 300, the result of encoding and then decoding the base layer using a codec, e.g., an advanced video codec (AVC) 75, and then upsampling the decoded base layer may be provided as the prediction frame P. Downsampling using wavelet transform and upsampling using inverse wavelet transform will be described in detail with reference to FIG. 4. Here, the result of encoding and then decoding the base layer using the AVC 75 is represented with Q₁·W(O). The multiplication of two functions indicates that execution of the functions progresses from the right to the left. Q₁( ) is a function indicating AVC quantization.

Instead of the upsampled base layer, a temporally prediction frame Oᵣ may be provided as the prediction frame P as in a typical method. Here, a frame obtained by upsampling the base layer is represented with W⁻¹·Q₁·W(O) while a temporal reference frame is represented with Oᵣ. Then, a residual frame E can be expressed by Equation 1 when the base layer is used as the prediction frame and can be expressed by Equation 2 when the temporal reference frame is used as the prediction frame. Here, upsampling using inverse wavelet transform is represented with W⁻¹( ).
E=O−W⁻¹·Q₁·W(O) (1)
E=O−Oᵣ (2)

A pre-decoder 200 extracts a low band of the residual frame to accomplish spatial scalability and cuts and discards a part of the low band from the end to accomplish picture quality scalability. A result having the spatial scalability and the picture quality scalability is represented with W·Q₂(E), which is transmitted to the decoder 300. Q₂( ) indicates wavelet quantization. Here, temporal scalability is not considered because the temporal picture quality of a single frame is considered in the present invention.

Meanwhile, when the base layer is used as a reference frame, the decoder 300 uses the base layer Q₁·W(O) generated in the encoder as a frame P′ (hereinafter, referred to as a “decoding prediction frame”) to be added for restoration. Then, an output D can be expressed by Equation 3.
D=Q₁·W(O)+W·Q₂(E) (3)

The addition is performed by an inverse temporal filtering module 90 in the decoder 300. If the pre-decoder 200 is provided with sufficient bits, the wavelet quantization effect Q₂ can be eliminated. Accordingly, regardless of an AVC quantization effect Q₁, the output D approximates to the wavelet downsampled original signal W(O), as expressed in Equation 4.

$$\begin{matrix}D = {Q}_{1} \cdot W ( O ) + W \cdot {Q}_{2} ( E ) \\ \approx {Q}_{1} \cdot W ( O ) + W ( E ) \\ = {Q}_{1} \cdot W ( O ) + W ( O - {W}^{- 1} \cdot {Q}_{1} \cdot W ( O ) ) \\ \approx {Q}_{1} \cdot W ( O ) + W ( O ) - W \cdot {W}^{- 1} \cdot {Q}_{1} \cdot W ( O ) \\ \approx W ( O )\end{matrix} \qquad ( 4 )$$

When the decoder 300 restores an image using a temporal reference frame, a previously restored frame W·Q₂(Oᵣ) can be used as the decoding prediction frame P′. Here, the output D can be expressed by Equation 5 indicating that a result of pre-decoding the current residual frame E and a result of pre-decoding the reference frame Oᵣ are summed by the decoder 300 for restoration.
D=W·Q₂(O)=W·Q₂(Oᵣ+E)=W·Q₂(Oᵣ)+W·Q₂(E) (5)

In Equations 3 through 5, the output D, i.e., the final result of restoration, is obtained when the pre-decoder 200 performs downsampling using wavelet transform. Accordingly, the output D has a very high detail level and does not have better visual picture quality than a result of MPEG-downsampling or a result of downsampling using an AVC. However, since encoding is performed using wavelet transform to accomplish spatial scalability, spatial downsampling is also performed using the wavelet transform in the pre-decoder 200. Such wavelet-based coding is advantageous in that spatial scalability is fundamentally supported and a result of performing upsampling after downsampling is very satisfactory.

The present invention provides a method of increasing the picture quality of a video output from the decoder 300 by employing high restorability accomplished by down/upsampling of wavelet-based coding and visually soft picture quality accomplished by downsampling of coding, such as AVC and MPEG coding, (hereinafter, assumed as MPEG coding).

A smoothing filter S( ) according to an exemplary embodiment of the present invention can be defined as Equation 6.
S( )=M·W⁻¹( ) (6)
where M( ) indicates an MPEG-downsampling filter. According to Equation 6, a smoothing filter performs upsampling using inverse wavelet transform, and then an MPEG-downsampling filter is used. This type of filter has equal attributes to the MPEG downsampling filter in light of visual picture quality. When a frame A is downsampled by a wavelet filter in the pre-decoder 200, the downsampled frame can be represented with W(A). If the smoothing filter is additionally used, the result is expressed by Equation 7.
S·W(A)=M·W⁻¹·W(A)≈M(A) (7)

W⁻¹·W( ) is not a fully reversible function but has a lot of reversibility in light of the attributes of a wavelet. Accordingly, the result of the function approximates to a result of MPEG-downsampling the original frame A. In other words, the result of the function has a smoothing effect of the MPEG-downsampling, and therefore, visual picture quality can be increased.

Such method does not provide completely the same result as the result of processing an original frame using an MPEG-downsampling filter, but the method provides remarkably softer picture quality. Therefore, this method can be effectively used with respect to a scalable video stream having a low bit rate.

The output D of the decoder 300 is expressed by Equations 3 and 5. An output D_{F} obtained by processing the output D using a smoothing filter is expressed by Equation 8 as follows:
D_{F}=S(D)=S·Q₁·W(O)+S·W·Q₂(E) when a base layer is used as a reference frame;
D_{F}=S(D)=S·W·Q₂(Oᵣ)+S·W·Q₂(E) when a temporal reference frame is used. (8)

Equation 8 indicates that a smoothing filter S can be expressed in two ways. As is indicated by S(D), the smoothing filter S may be used at an output terminal of the decoder 300 or may be used before two components Q₁·W(O) and W·Q₂(E) or W·Q₂(Oᵣ) and W·Q₂(E) are summed.

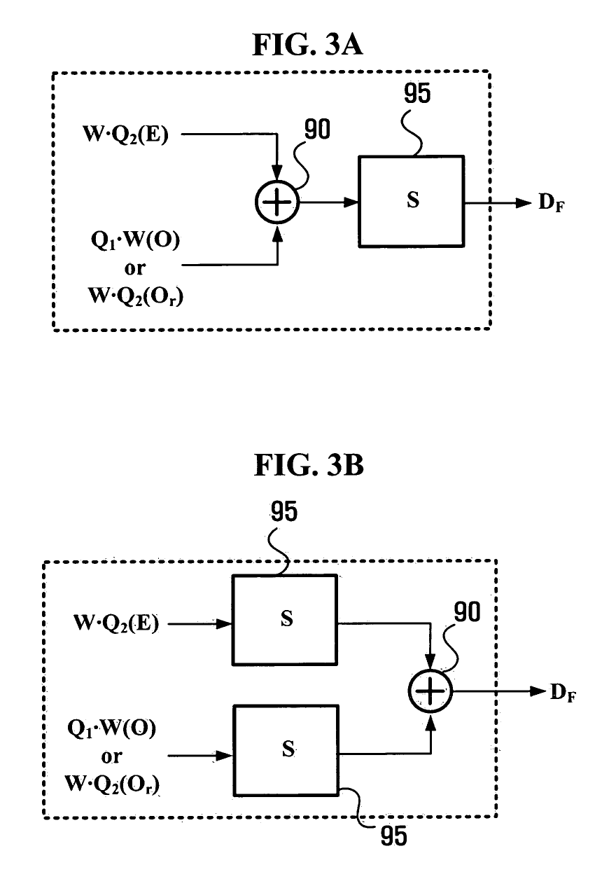

FIG. 3A illustrates the former case and FIG. 3B illustrates the latter case.

As defined by Equation 7, the smoothing filter S performs wavelet-based upsampling and non-wavelet-based downsampling. Non-wavelet-based downsampling indicates downsampling performed by a codec like an MPEG codec or an AVC using DCT. FIG. 4 illustrates downsampling through wavelet transform and upsampling through inverse wavelet transform. In downsampling, wavelet transform is performed with respect to an input frame so that the input frame is divided into four bands, as shown in FIG. 4. If only an LL band (low band) is selected, a frame downsampled by a factor of two can be obtained. A procedure performed in the pre-decoder 200 to reduce a spatial scale is performed in the same manner as the downsampling.

In upsampling, the LL band is set as an input frame and the other bands are set to “0”. Thereafter, inverse wavelet transform is performed. Then, a frame upsampled by a factor of two can be obtained.

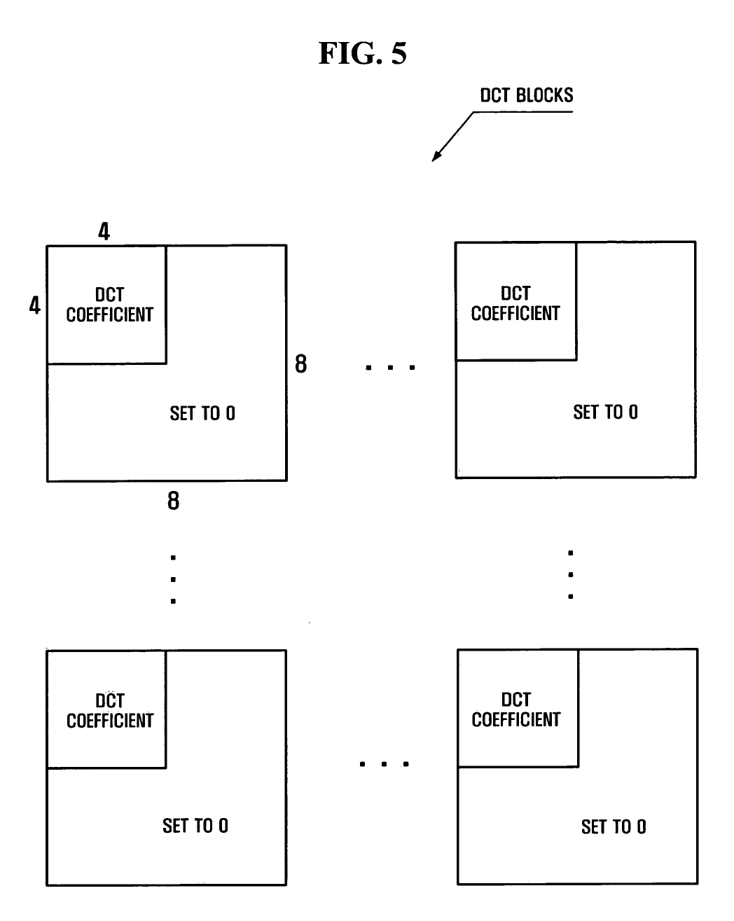

Meanwhile, DCT-based down/upsampling is performed as shown in FIG. 5. Although energy is concentrated upon an upper left portion in each DCT block, the DCT blocks are uniformly scattered throughout a frequency-domain frame, as shown in FIG. 5. However, as shown in FIG. 4, in wavelet transform, energy is concentrated upon an upper left portion in a wavelet-domain frame. Accordingly, a frame downsampled through the wavelet transform has detailed picture quality while a frame downsampled through the DCT has soft picture quality. Due to this characteristic of a wavelet, it is difficult to expect a good result of downsampling when a bit rate is low. An MPEG-codec and an AVC perform spatial transform, downsampling, and upsampling using DCT.

In DCT-based downsampling, an input frame is converted to a frequency-domain frame through 8*8 DCT. The converted frame is composed of a plurality of DCT blocks, as shown in FIG. 5. Usually, each DCT block has a size of 8*8 pixels. Upper left ¼ regions (having a size of 4*4 pixels) are collected from the respective DCT blocks and then are subjected to 4*4 inverse DCT to generate a frame downsampled by a factor of two. In DCT-based upsampling, an input frame is subjected to 4*4 DCT. DCT coefficients obtained as the result of the 4*4 DCT are arranged as shown in FIG. 5 and the other dark regions are set to 0. Thereafter, 8*8 inverse DCT is performed to generate a frame upsampled by a factor of two.

Hereinafter, the structures and operations of the encoder 100, the pre-decoder 200, and the decoder 300 included in a scalable video coding system according to the present invention will be described.

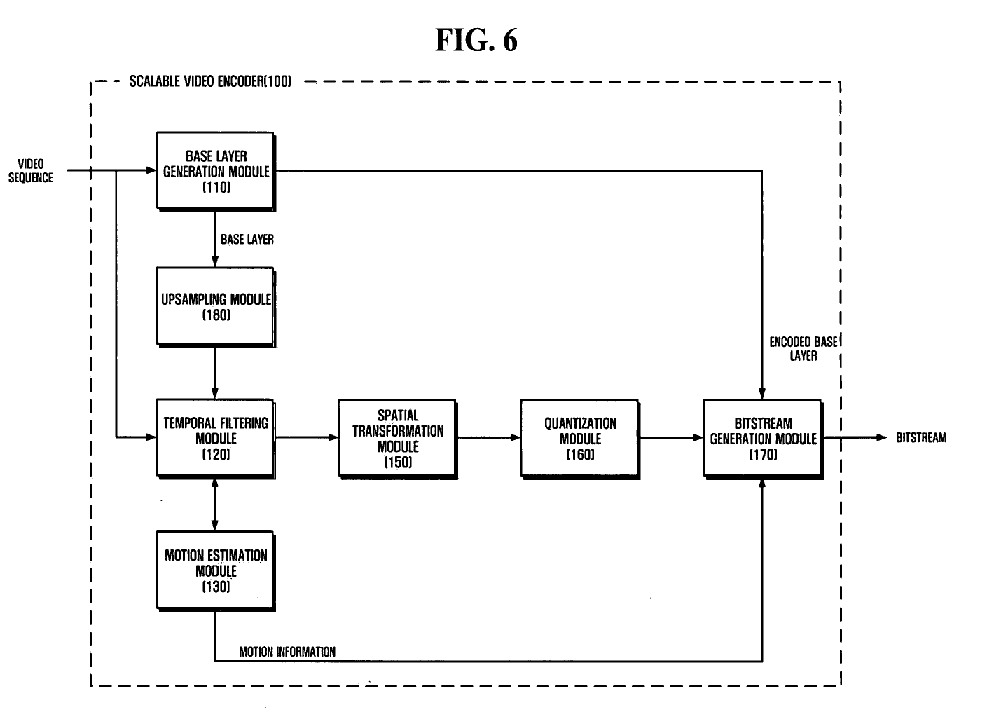

FIG. 6 is a diagram of a scalable video encoder 100 according to an exemplary embodiment of the present invention. The scalable video encoder 100 may include a base layer generation module 110, a temporal filtering module 120, a motion estimation module 130, a spatial transformation module 150, a quantization module 160, a bitstream generation module 170, and an upsampling module 180.

An input video sequence is input to the base layer generation module 110 and the temporal filtering module 120. The base layer generation module 110 downsamples the input video sequence into a video sequence having a minimum resolution, thereby generating a base layer, encodes the base layer using a predetermined codec, and provides the encoded base layer to the bitstream generation module 170. The base layer generation module 110 also provides the generated base layer to the upsampling module 180. Various methods can be performed for downsampling, but it is preferable to use wavelet transform for downsampling in aspect of resolution.

As described above, a spatially downsampled video sequence, i.e., the base layer may be directly provided to the upsampling module 180. However, with consideration of the balance with a case where the base layer is restored in a decoder, the base layer encoded using the codec may be decoded using the same codec and then provided to the upsampling module 180. In other words, one among the spatially downsampled video sequence and the result of encoding and then decoding the spatially downsampled video sequence may be provided to the upsampling module 180. Hereinafter, both of the spatially downsampled video sequence and the result of encoding and then decoding are referred to as a base layer.

Preferably, but not necessarily, the codec used here provides good picture quality at a low bit rate. For example, a non-wavelet codec such as an H.264 codec or an MPEG-4 codec may be used. Here, “good picture quality” means that there is only a small distortion from an original image when the original image is restored after being compressed at a certain bit rate. A peak signal-to-noise ratio (PSNR) is usually used as a reference for picture quality.

The upsampling module 180 upsamples the base layer generated by the base layer generation module 110 to have the same resolution as a frame to be subjected to temporal filtering. Here, it may be preferable to perform the upsampling using inverse wavelet transform.

Meanwhile, the temporal filtering module 120 decomposes a frame into a low-pass frame and a high-pass frame in a time axis direction, thereby reducing temporal redundancy. In an exemplary embodiment of the present invention, the temporal filtering module 120 can perform filtering in a temporal direction and can also perform filtering using a difference between the upsampled base layer and a corresponding frame. Filtering performed in the temporal direction is referred to as temporal residual coding, and filtering using the difference between the upsampled base layer and the corresponding frame is referred to as difference coding. As described above, in the present invention, temporal filtering includes temporal residual coding and difference coding.

The motion estimation module 130 performs motion estimation based on a reference frame. The temporal filtering module 120 can control the motion estimation module 130 to perform the motion estimation and can receive the result of the motion estimation from the motion estimation module 130, when necessary. Examples of the temporal filtering include MCTF, UMCTF, and so on.

Upon receiving a call from the temporal filtering module 120, the motion estimation module 130 performs motion estimation on a current frame based on the reference frame determined by the temporal filtering module 120, thereby obtaining a motion vector (MV). A block matching algorithm is usually used for the motion estimation. In detail, a given block is moved in pixel units within a particular search area in the reference frame, and displacement giving a minimum error is estimated as a MV. For the motion estimation, a fixed block may be used, but a hierarchical method using hierarchical variable size block matching (HVSBM) may be used. The motion estimation module 130 provides to the bitstream generation module 170, motion information including a reference frame number, a MV, and a block size obtained as the results of the motion estimation.

The spatial transformation module 150 performs spatial transformation supporting spatial scalability with respect to the frame in which temporal redundancy is removed by the temporal filtering module 120, thereby removing spatial redundancy. Wavelet transform is used for the spatial transformation. Coefficients obtained by performing the spatial transformation are referred to as transformation coefficients.

In a detailed example of using the wavelet transform, the spatial transformation module 150 decomposes the frame from which temporal redundancy is removed into a low sub-band and a high sub-band using wavelet transform and obtains wavelet coefficients for the respective sub-bands.

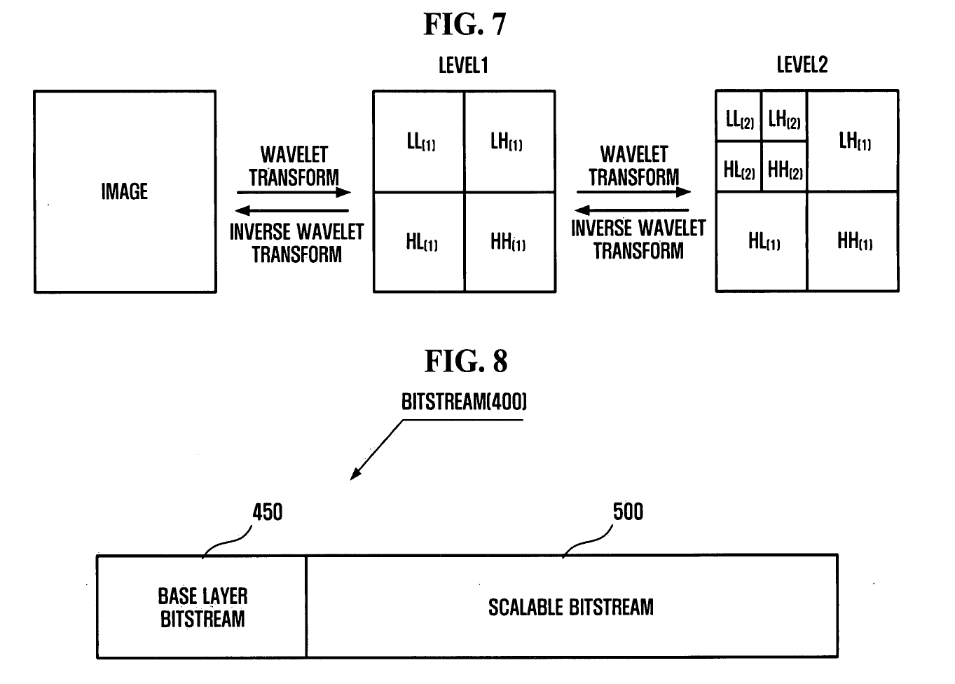

FIG. 7 illustrates an example of a procedure for decomposing an input image or frame into sub-bands using wavelet transform. Decomposition is performed in two levels. There are three types of high sub-bands in horizontal, vertical, and diagonal directions, respectively. A low sub-band, i.e., a sub-band having a low frequency in both of the horizontal and vertical directions, is expressed as “LL”. The three types of high sub-bands, i.e., a horizontally high sub-band, a vertically high sub-band, and a horizontally and vertically high sub-band, are expressed as “LH”, “HL”, and “HH”, respectively, wherein numerals in parenthesis indicate a wavelet transform level. The low sub-band is decomposed again.

The quantization module 160 quantizes a transformation coefficient obtained by the spatial transformation module 150. Quantization is a process of dividing the transformation coefficient expressed in a real number by a predetermined quantization step size to generate a discrete value and matching the discrete value to a predetermined index. In particular, when wavelet transformation is used as spatial transformation, embedded quantization is typically used. Examples of the embedded quantization include Embedded Zerotrees Wavelet Algorithm (EZW), Set Partitioning in Hierarchical Trees (SPIHT), and Embedded ZeroBlock Coding (EZBC).

The bitstream generation module 170 performs lossless coding on the encoded base layer data received from the base layer generation module 110, the quantized transformation coefficient received from the quantization module 160, and the motion information received from the motion estimation module 130 and generates an output bitstream. To perform the lossless coding include, a variety of entropy encoding techniques, including arithmetic coding, variable-length coding, etc. may be performed.

Meanwhile, the pre-decoder 200 can simply accomplish scalability by clipping a part of a bitstream received from the encoder 100 according to an extraction condition considering an environment of communication with the decoder 300. The fact that picture quality, resolution, or a frame rate can be decreased just by clipping a part of a bitstream is one of the advantages of scalable video coding.

FIG. 8 illustrates the structure of a bitstream 400 transmitted from the encoder 100. The bitstream 400 may include a base layer bitstream 450 obtained by performing lossless coding on the encoded base layer and a scalable bitstream 500 obtained by performing lossless coding on the transformation coefficient that has temporal and spatial scalability and transmitted from the quantization module 160. When the bitstream 400 is generated by a scalable video encoder that does not use a base layer, the base layer bitstream 450 is not present.

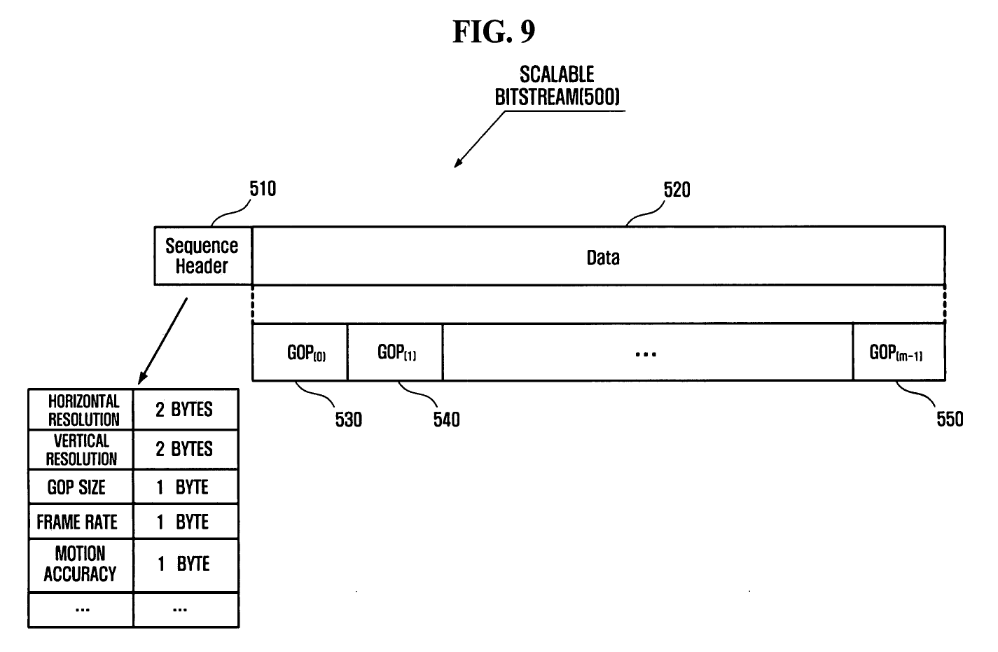

Referring to FIG. 9, the scalable bitstream 500 may include a sequence header field 510 and a data field 520. The data field 520 may include one or more groups of pictures (GOPs) fields 530, 540, and 550. Features of an image, such as a horizontal resolution (two bytes) and vertical resolution (two bytes) of a frame, a GOP size (one byte), and a frame rate (one byte), are recorded in the sequence header field 510. Data expressing an image and other information (e.g., motion information) needed for image restoration are recorded in the data field 520.

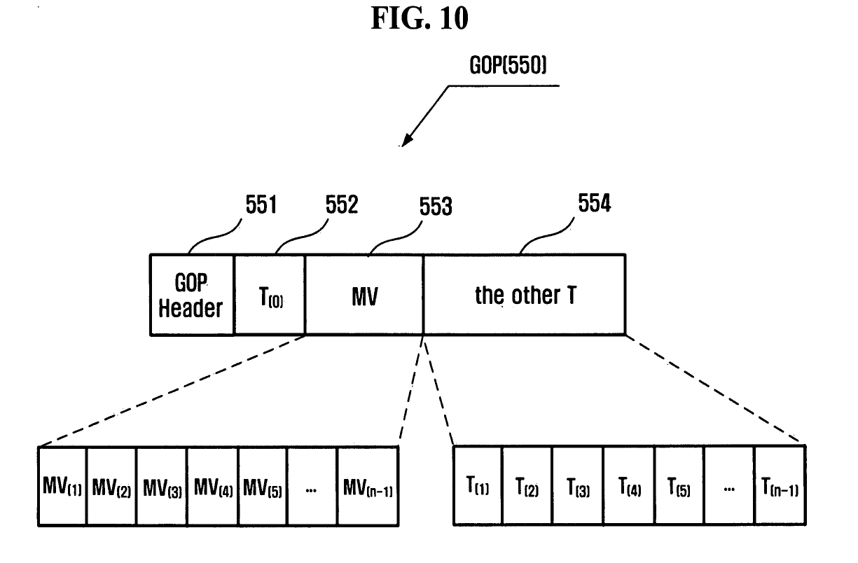

FIG. 10 illustrates the detailed structure of each GOP field 510, 520, or 550. Each GOP field 510, 520, or 550 may include a GOP header 551, a T₍₀₎ field 552 containing information regarding a frame that is encoded without referring to another frame in a time domain, a MV field 553 containing motion information, and “the other T” field 554 containing information regarding a frame that is encoded referring to another frame. The motion information includes a block size, a MV of each block, a number (referred to as a reference frame number) designating a reference frame referred to obtain the MV, etc. A number of one of temporally relevant frames or a number (which may be a particular number that is not allocated to other frames) designating a base layer frame when difference coding is performed may be recorded as the reference frame number. As described above, with respect to a block generated through the difference coding, a reference frame is present, but a MV does not exist.

The MV field 553 includes MV₍₁₎ through MV₍ₙ₋₁₎ fields for respective frames. The “the other T” field 554 includes T₍₁₎ through T₍ₙ₋₁₎ fields containing texture data of the respective frames. Here, “n” denotes a GOP size. Referring to FIG. 9, a low-pass frame is positioned at the start point of a GOP and the number of low-pass frames is one, but this configuration is just an example. According to a temporal estimation scheme at a terminal of the encoder 100, two or more low-pass frames may be present and may be positioned at a place other than the start point of the GOP.

When the pre-decoder 200 operates to decrease a temporal scale, some of the T₍₁₎ through T₍ₙ₋₁₎ fields and their corresponding MVₙ fields are omitted and only the other fields are extracted. When decreasing a spatial scale, only an LL band (LL₍₁₎ or LL₍₂₎ shown in FIG. 7) in each of the T₍₁₎ through T₍ₙ₋₁₎ fields is extracted since wavelet transform has been already done. In addition, when decreasing picture quality, part of data is cut from the back in each of the T₍₁₎ through T₍ₙ₋₁₎ fields and is discarded, and only the remaining data is extracted.

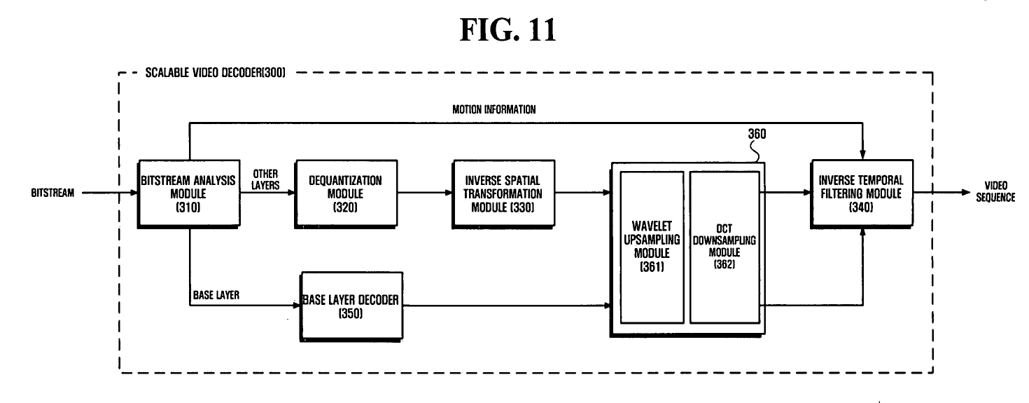

FIG. 11 illustrates a scalable video decoder 300 according to an exemplary embodiment of the present invention. The scalable video decoder 300 may include a bitstream analysis module 310, a dequantization module 320, an inverse spatial transformation module 330, an inverse temporal filtering module 340, a base layer decoder 350, and a smoothing filter module 360.

The bitstream analysis module 310 performs entropy encoding in a reverse way, i.e., analyses an input bitstream and separately extracts information of a base layer and information of the other layers. If the input bitstream does not include the information of the base layer, the base layer decoder 350 may not be provided in the scalable video decoder 300. Here, the information of the base layer is provided to the base layer decoder 350. Texture information among the information of the other layers is provided to the dequantization module 320, and motion information thereamong are provided to the inverse temporal filtering module 340.

The base layer decoder 350 decodes the information of the base layer received from the bitstream analysis module 310 using a predetermined codec, which corresponding to a codec used for encoding. It may be preferable to use an H.264 codec or an MPEG-4 codec having good performance at a low bit rate.

The dequantization module 320 dequantizes the texture information received from the bitstream analysis module 310 and outputs a transformation coefficient. Dequantization is a process of finding a quantized coefficient matched to a value expressed in a predetermined index by the encoder 100. A table presenting the matching relationship between an index and a quantized coefficient may be transmitted from the encoder 100 or may have been agreed between the encoder 100 and the decoder 300.

The inverse spatial transformation module 330 performs spatial transformation in a reverse way to convert transformation coefficients into a residual frame in a spatial domain. When spatial transformation has been performed using a wavelet method, a transformation coefficient in the wavelet domain into a transformation coefficient in the spatial domain.

The smoothing filter module 360 may include a wavelet upsampling module 361 performing wavelet-based upsampling and a DCT downsampling module 362 performing DCT-based downsampling used in an MPEG codec or an AVC. As described above with reference to FIG. 4, wavelet-based upsampling is performed by setting an input frame to a low band, setting the other bands 0, and performing inverse wavelet transform. As described above with reference to FIG. 5, DCT-based upsampling is performed by converting an input frame into a frequency-domain frame using 8*8 DCT, collecting upper left ¼ regions in respective DCT blocks obtained as the result of the 8*8 DCT, and performing 4*4 inverse DCT with respect to the collected upper left ¼ regions.

The inverse temporal filtering module 340 performs inverse temporal filtering with respect to an output from the smoothing filter module 360 to restore a video sequence. To perform the inverse temporal filtering, the inverse temporal filtering module 340 may use the motion information received from the bitstream analysis module 310 and the base layer received from the base layer decoder 350.

The inverse temporal filtering is performed in a manner reverse to temporal filtering performed in the encoder 100. In other words, when difference coding (inter-layer coding) has been performed for the filtering in the encoder 100, the output from the smoothing filter module 360 and a corresponding base layer are summed. When temporal prediction coding has been performed for the filtering in the encoder 100, the output from the smoothing filter module 360 and a prediction frame made using a reference frame number and a motion vector are summed.

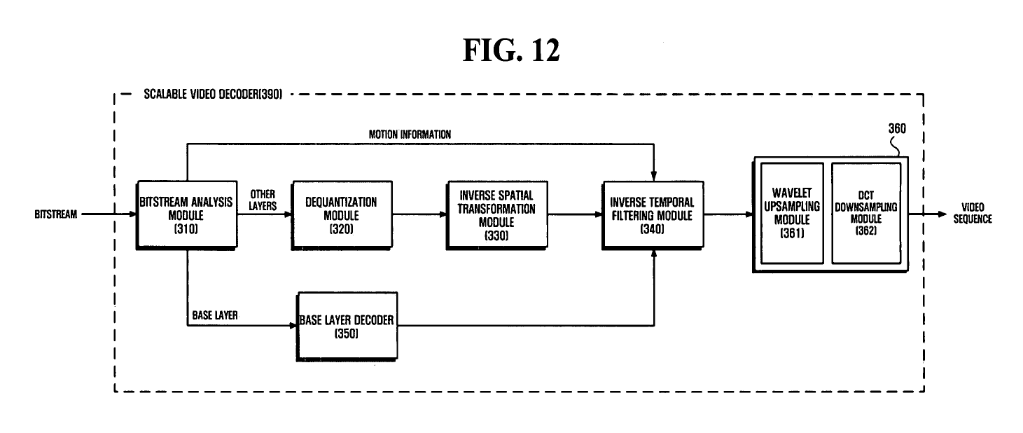

FIG. 12 illustrates a scalable video decoder 390 according to another exemplary embodiment of the present invention. The scalable video decoder 390 shown in FIG. 12 has the same elements as the scalable video decoder 300 shown in FIG. 11 but has a different operating order. In the scalable video decoder 300 shown in FIG. 11, the smoothing filter module 360 is used before inverse temporal filtering. Unlikely, in the scalable video decoder 390 shown in FIG. 12, after the inverse temporal filtering, the smoothing filter module 360 is used before generating a final output. However, as is mentioned in the description of Equation 8, both of the scalable video decoder 300 and the scalable video decoder 390 are almost similar in light of effects.

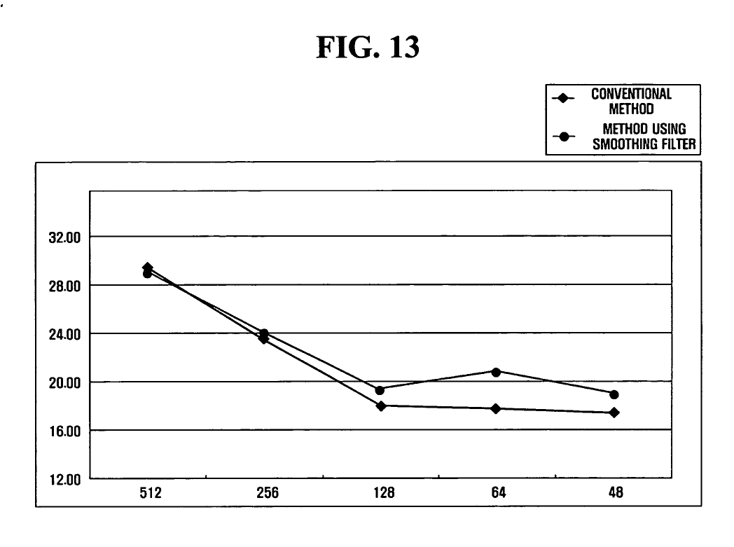

FIG. 13 is a graph of a bit rate versus a PSNR in a Mobile sequence. A method of the present invention provides a similar result to conventional scalable video coding at a high bit rate and provides a much better result at a low bit rate. The graph shown in FIG. 13 proves that performance of DCT-based downsampling is superior to the performance of wavelet-based downsampling at a low bit rate.

Accordingly, the present invention increases the objective picture quality of an output image of a scalable video decoder. In addition, the present invention provides an output image having visually soft picture quality to users, thereby also increasing subjective picture quality.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

What is claimed is:

1. A video decoding method comprising:
generating a residual frame from an input bitstream;
performing wavelet-based upsampling on the residual frame to generate an upsampled frame;
performing non-wavelet-based downsampling on the upsampled frame to generate a downsampled frame; and
performing inverse temporal filtering on the downsampled frame.

2. The video decoding method of claim 1, wherein the non-wavelet-based downsampling is discrete cosine transform (DCT)-based downsampling.

3. The video decoding method of claim 1, wherein the performing of the wavelet-based upsampling comprises:
setting the residual frame to a low band;
setting other bands to 0; and
performing inverse wavelet transform.

4. The video decoding method of claim 2, wherein the performing of the non-wavelet-based downsampling comprises:
converting the residual frame into a frequency-domain frame using a DCT of a predetermined size;
collecting upper left ¼ regions in DCT blocks generated through the DCT; and
performing inverse DCT on the upper left ¼ regions which are collected.

5. The video decoding method of claim 1, further comprising, before the performing of the inverse temporal filtering:
extracting a base layer from the input bitstream and decoding the base layer to generate a decoded base layer; and
performing wavelet-based upsampling and non-wavelet-based downsampling on the decoded base layer; and
providing a result of the upsampling and downsampling as a prediction frame used for the inverse temporal filtering.

6. A video decoding method comprising:
generating a residual frame from an input bitstream;
performing inverse temporal filtering on the residual frame to restore a video sequence;
performing wavelet-based upsampling on the video sequence to generate a upsampled video sequence; and
performing non-wavelet-based downsampling on the upsampled video sequence.

7. The video decoding method of claim 6, wherein the non-wavelet-based downsampling is discrete cosine transform (DCT)-based downsampling.

8. A video decoder comprising:
an inverse spatial transformation module which generates a residual frame from an input bitstream;
a smoothing filter module which performs wavelet-based upsampling on the residual frame to generate an upsampled frame and non-wavelet-based downsampling on the upsampled frame to generate a downsampled frame; and
an inverse temporal filtering module which performs inverse temporal filtering on the downsampled frame.

9. The video decoder of claim 8, wherein the non-wavelet-based downsampling is discrete cosine transform (DCT)-based downsampling.

10. The video decoder of claim 8, wherein the smoothing filter module performs the wavelet-based upsampling on the residual frame by setting the residual frame to a low band, setting other bands to 0, and performing inverse wavelet transform.

11. The video decoder of claim 9, wherein the smoothing filter module performs the non-wavelet-based downsampling on the upsampled frame by converting the upsampled frame into a frequency-domain frame using a DCT of a predetermined size, collecting upper left ¼ regions in DCT blocks generated through the DCT, and performing inverse DCT on the upper left ¼ regions which are collected.

12. The video decoder of claim 8, further comprising a base layer decoder which extracts a base layer from the input bitstream and decodes the base layer to generate a decoded base layer, wherein the smoothing filter module performs the wavelet-based upsampling and the non-wavelet-based downsampling on the decoded base layer.

13. A video decoder comprising:
an inverse spatial transformation module which generates a residual frame from an input bitstream;
an inverse temporal filtering module which performs inverse temporal filtering on the residual frame to restore a video sequence; and
a smoothing filter module which performs wavelet-based upsampling and non-wavelet-based downsampling on the video sequence.

14. The video decoder of claim 13, wherein the non-wavelet-based downsampling is discrete cosine transform (DCT)-based downsampling.

15. A recording medium having a computer readable program recorded therein, the program for executing a video decoding method which comprises:
generating a residual frame from an input bitstream;
performing wavelet-based upsampling on the residual frame to generate an upsampled frame;
performing non-wavelet-based downsampling on the upsampled frame to generate a downsampled frame; and
performing inverse temporal filtering on the downsampled frame.
